(19) United States
(12) Patent Application Publication
(10) Pub. No.: US 2025/0341174 A1
(43) Pub. Date: Nov. 6, 2025

(54) PANEL SEGMENT FOR A COOLING PANEL

(71) Applicant: MTU Aero Engines AG, Muenchen (DE)

(72) Inventors: Krzysztof MARZEC, Rzeszow (PL); Marek TABOR, Stalowa Wola (PL)

(21) Appl. No.: 19/273,204

(22) Filed: Jul. 18, 2025

(30) Foreign Application Priority Data
Jul. 30, 2024 (EP) 24191875.4

(51) Int. Cl. F01D 25/14; F01D 25/12

(52) U.S. Cl. CPC F01D 25/14; F01D 25/12; F05D 2260/201

(57) ABSTRACT

A cooling panel for a casing structure of a turbomachine, including: an inner sheet made of sheet metal; and an outer sheet made of sheet metal; the outer sheet being arranged radially outside of the inner sheet and being materially connected to the inner sheet, wherein circumferential cooling channels are defined between the inner sheet and the outer sheet, each circumferential cooling channel being provided with a row of cooling holes, configured to eject cooling fluid radially inwards, the panel segment further defining an axial distributor volume, configured to supply the circumferential cooling channels with the cooling fluid. A circumferential distribution channel is in fluid communication with the axial distributor volume and has a first interface at the first end and a second interface at the second end, the first interface and the second interface configured to be connected to a respective neighboring panel segment.

This claims priority to European Patent Application 24191875.4, filed Jul. 30, 2024 which is hereby incorporated by reference herein.

The present application relates to a panel segment for a cooling panel for a casing structure of a turbomachine.

### BACKGROUND

Turbomachines can be used in jet engines, e.g. turbofan engines. Functionally, the turbomachine may be divided into a compressor, a combustion chamber and a turbine. In case of the jet engine, for example, air that is sucked in is compressed by the compressor and burned with added fuel, e.g. kerosene, in the combustion chamber located downstream. The resulting hot gas, a mixture of combustion gas and air, flows through the turbine located downstream and is expanded in this process. The turbine extracts energy from the hot gas to drive the compressor, for instance.

Radially outside of the gas channel, e.g. compressor gas channel in the compressor or hot gas channel in the turbine, a casing structure of the engine is arranged. To lower a temperature in the casing structure, a cooling may be implemented, wherein a temperature reduction can for instance extend the range of materials applicable for parts of the casing structure.

### SUMMARY OF THE INVENTION

For cooling the casing structure, a cooling panel or a respective panel segment thereof may define a plurality of circumferential cooling channels, each being provided with a row of cooling holes. In operation, a cooling fluid, e.g. compressed air, can be fed through the cooling channels and be ejected via the cooling holes radially inwards. The ejected cooling fluid can provide an impingement cooling to the casing structure arranged radially inside of the panel segment or cooling panel.

It is an object of the present invention to provide an advantageous panel segment for a cooling panel.

The present invention provides that the panel segment comprises an inner sheet and an outer sheet, respectively made of sheet metal. The outer sheet is arranged radially outside of the inner sheet and materially connected to the inner sheet. Between the inner and the outer sheet, the circumferential cooling channels are defined, e.g. with the cooling holes provided in the inner sheet for the cooling fluid ejection radially inwards. These circumferential cooling channels are supplied via an axial distributor volume which is also defined in the panel segment. Further, the panel segment defines a circumferential distribution channel which is fluidically connected to the axial distributor volume. The circumferential distribution channel extends from a first end to a circumferentially opposite second end of the panel segment and has a first interface at the first end and a second interface at the second end.

In other words, the circumferential distribution channel extends between the circumferential ends of the segment and has an interface, i.e. connection point, at each circumferential end. Via these interfaces, i.e. connection points, the panel segment can be connected to neighboring panel segments to form a continuous channel over the circumference. The circumferential distribution channel is integrated into the panel segment, so that for instance no separate circumferential pipe has to be mounted onto the panel segment for a circumferential distribution of the cooling fluid. The panel segment, e.g. each panel segment of the cooling panel, has its own circumferential channel portion, which can for instance reduce the number of individual parts and mounting effort, thus.

Further embodiments can be found in the dependent claims and in the entire disclosure, wherein in the description of the features, a distinction is not always made in detail between device and method or use aspects, the disclosure is to be read with respect to all claim categories. If, for example, a panel segment is described, this relates also to a cooling panel comprising one or a plurality of such panel segments.

Generally, “axial”, “radial” and “circumferential”, as well as the respective directions (“axial direction” and so on), relate to an axis of curvature around which the panel segment is curved. With respect to this axis of curvature, parts or elements of the panel segment e.g. the circumferential cooling channels or the cooling holes, can have a rotationally symmetrical arrangement. Considering a cooling panel comprising a plurality of panel segments, these segments may be arranged rotationally symmetrically around this axis. Considering a module of the turbomachine, or the turbomachine as a whole, the axis of curvature may coincide with a length axis of the module or turbomachine (around this longitudinal axis the rotor stages may rotate, for instance).

The first end and the second end of the panel segment lie circumferentially opposite, i.e. opposite to each other with respect to the circumferential direction. In an assembled cooling panel, which comprises a plurality of panel segments, each of the first and the second end may lie adjacent to a respective neighboring panel segment of the cooling panel. The circumferential cooling channels, which are provided with the cooling holes, respectively have their length extension in the circumferential direction, e.g. from the axial distributor volume in the circumferential direction to the first end or the second end of the panel segment. Therein, a respective cooling channel may end inside the panel segment, e.g. have an end which is offset circumferentially inwards from the respective end of the panel segment.

The axial distributor volume may be radially defined between the inner and the outer sheet. With respect to the circumferential direction, the axial distributor volume can for instance be arranged on a rather central position, e.g. between 30% to 70%, in particular 40% to 60%, of the circumferential extension of the panel segment (0% is at the first end 100% is at the second end of the panel segment). Independently of its specific position, at least one cooling channel may be arranged on each circumferential side of the axial distributor volume. In an embodiment, at least two cooling channels, in particular at least three cooling channels, are arranged on each circumferential side of the axial distributor volume (possible upper limits being for instance at most 10, 8 or 6 cooling channels per side). Considering those cooling channels which are respectively arranged on the same circumferential side of the axial distributor volume, these cooling channels may be arranged axially consecutive, i.e. branch off from the axial distributor volume at consecutive axial positions.

In addition to the fluid communication with the circumferential distribution channel, the axial distributor volume may comprise an interface, e.g. radially outwards, configured for receiving the cooling fluid. Via this interface of the axial distributor volume, a cooling fluid supply pipe system can be connected when a module or stage of the turbomachine is assembled, the cooling fluid in operation being guided from radially outside through the channel system of the panel segment or cooling panel through the cooling holes radially inwards. Considering a cooling panel with a plurality of panel segments, only a subset or even only one panel segment, i.e. the axial distributor volume of this panel segment, can be connected to the cooling fluid supply, the axial distributor volumes of the remaining panel segments being supplied via the circumferential distribution channel and being closed radially outwards (i.e. having no interface radially outwards).

To define the cooling channel structure, the inner and the outer sheet are materially connected, i.e. are connected with a material bond. This can for instance be achieved by welding or brazing. Due to the material connection, the inner and outer sheet are provided as one piece, e.g. cannot be removed from each other in a non-destructive manner.

The first interface is arranged at the first end and the second interface is arranged at the second end, the respective interface being for instance spaced by not more than 5% or 3% of a circumferential extension of the panel segment from the respective end, or being arranged exactly at the respective end. The first and the second interface may be provided integrally with the panel segment, e.g. be respectively one-piece with the remaining panel segment in the sense just mentioned. The first and the second interface may be formed by at least one of the inner and the outer sheet, e.g. together with an additional element or part being permanently connected to the remaining panel segment (e.g. one piece in the sense just mentioned).

In an embodiment, the circumferential distribution channel is defined radially by the inner and/or the outer sheet. In other words, the inner and the outer sheet do not only define the cooling channel structure in between, in addition at least one of the sheets also defines the circumferential distribution channel.

The term “radially define a channel” can mean in particular, that the respective sheet forms at least one of the radial boundaries or a radial spatial limitations of the channel.

The circumferential distribution channel is in particular formed free of cooling holes and/or without cooling holes for the circumferential distribution of cooling air.

In an embodiment, the circumferential distribution channel is radially defined between the inner and the outer sheet, the inner sheet defining the circumferential distribution channel radially inwards and the outer sheet defining it radially outwards.

In an alternative embodiment, the panel segment comprises an additional channel sheet, which is made of sheet metal and defines the circumferential distribution channel radially. For that purpose, the additional channel sheet may be materially connected to one of the inner and the outer sheet, defining the circumferential distribution channel together with the respective sheet.

In general, the additional channel sheet may be arranged radially inside of the inner sheet, the inner sheet defining the circumferential distribution channel radially outwards and the additional channel sheet defining it radially inwards. In an embodiment, however, the additional channel sheet is arranged radially outside of the outer sheet, e.g. materially connected to the outer sheet. The circumferential distribution channel may then be defined radially outwards by the additional channel sheet and radially inwards by the outer sheet, i.e. by a radially outer surface of the outer sheet.

In an embodiment, the sheet metal, e.g. of the inner and/or outer sheet, or of the additional channel sheet, has a thickness of at least 0.4 millimeter, 0.7 millimeter or 1.0 millimeter. Possible upper limits, that shall be disclosed independently of the lower limits, can for instance be 1.5 millimeter, 2.0 millimeter or 2.5 millimeter. For example, the thickness can be in the range from 0.4 millimeter to 2 millimeter.

In an embodiment, a cooling panel comprises a first panel segment and a second panel segment, wherein a fluidical connection is formed between the first interface of the first panel segment and the second interface of the second panel segment. In the cooling panel, the first and second panel segment are arranged adjacent to each other, i.e. neighboring each other with respect to the circumferential direction. Over the whole circumference, the cooling panel may comprise further panel segments, to which the second interface of the first panel segment and the first interface of second panel segment are connected.

In an embodiment, the fluidical connection between the panel segments is realized by a flexible jumper tube. This may be pushed into the interface or onto a sleeve inserted into the interface. The flexible jumper tube may have a certain flexibility as to a circumferential relative displacement of the panel segments, which may for instance reduce an introduction of mechanical stress.

As an alternative to the flexible jumper tube, the connection between the neighboring panel segments may be a sliding female-male type connection. A male type connector may be slidably received in a female type connector, the resulting connection having a certain clearance with respect to a circumferential relative displacement (reduction of mechanical stress, see above).

In an embodiment, the cooling panel comprises a plurality of panel segments which together form a closed ring. Each of these panel segments may comprise a circumferential distribution channel extending between the first and the second end of the respective panel segment. In detail, each panel segment of the cooling panel may be provided as a panel segment as disclosed here. In detail, the panel segments may be identical in construction, e.g. apart from an open or closed radial interface to the respective axial distributer volume.

In an embodiment, the circumferential distribution channels of the plurality of panel segments are fluidically connected to form a continuous channel over the whole circumference. In other words, each panel segment has a circumferential distribution channel and between all panel segments a fluidical connection is formed, the resulting channel being a closed ring with respect to the circumferential direction.

In an embodiment, a module for a turbomachine comprises a casing structure and a cooling panel. The casing structure is arranged radially outside of a gas channel of the turbomachine, e.g. of the compressor or turbine gas channel. The cooling panel is mounted radially outside of the casing structure, the cooling fluid ejected radially inwards from the cooling holes providing an impingement cooling of the casing structure.

On its radially opposite inside, the casing structure may comprise a mounting element, e.g. a hook or flange protruding radially inwards. At this or these mounting structure(s), for instance a sealing arrangement, which is arranged radially outside of a rotor, or a stator can be mounted, e.g. a platform of the stator or stator vane being mounted at a hook of the casing structure by a form-fit. As mentioned, these mounting structures may be arranged on a radial inner side of the casing structure, its radially opposite outer side being cooled with the cooling panel.

In an embodiment, a method of using such a module may comprise:
distributing the cooling fluid circumferentially in the panel segments, i.e. through the circumferential distribution channels defined by the respective panel segments;
ejecting the cooling fluid from the cooling holes radially inwards, e.g. onto a radial outer surface of the casing structure.

In an embodiment, a method of manufacturing the panel segment or a cooling panel or a module comprises: bonding the inner sheet and the outer sheet of a respective panel segment together by materially joining, for instance by brazing or welding.

### BRIEF DESCRIPTION OF THE DRAWINGS

Below, the panel segment, cooling panel and module, as well as related methods, are explained in further detail by means of exemplary embodiments. Therein, the individual features can also be relevant in a different combination.

FIG. 1 shows a schematic cross-sectional view of a turbomachine to illustrate the field of application;

FIG. 2 illustrates a panel segment in an oblique view;

FIG. 3 shows a partially exploded view of the panel segment of FIG. 2;

FIG. 4a illustrates a panel segment in a schematic cross-section;

FIG. 4b shows different channels in the cooling panel of FIG. 4 in a schematic radial top view;

FIGS. 5a and 5b illustrate different possibilities of connecting panel segments to a cooling panel;

FIG. 6 illustrates a cooling panel mounted on a casing structure in a schematic actual cross-section.

### DETAILED DESCRIPTION

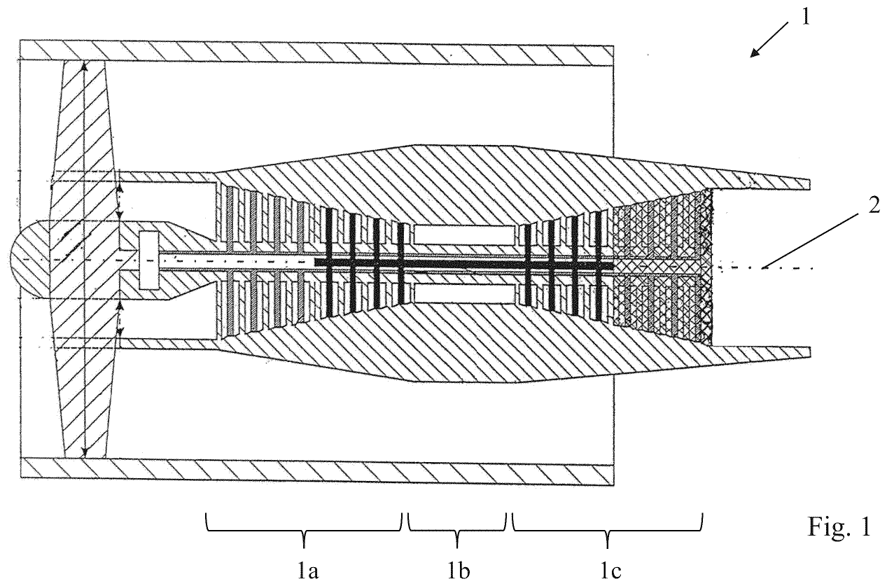

FIG. 1 shows a turbomachine 1, specifically a turbofan engine, in an axial section. The turbomachine 1 is functionally divided into a compressor 1a, a combustion chamber 1b, a turbine 1c and a fan 1d. Both the compressor 1a and the turbine 1c are each made up of several stages, each stage comprising a stator vane ring and a rotor blade ring. During operation, the rotor blade rings rotate around the length axis 2 of the turbomachine 1, and air sucked in is compressed in the compressor 1a and then burned with fuel in the combustion chamber 1b. The resulting hot gas is expanded in the turbine 1c and drives the rotor blade rings.

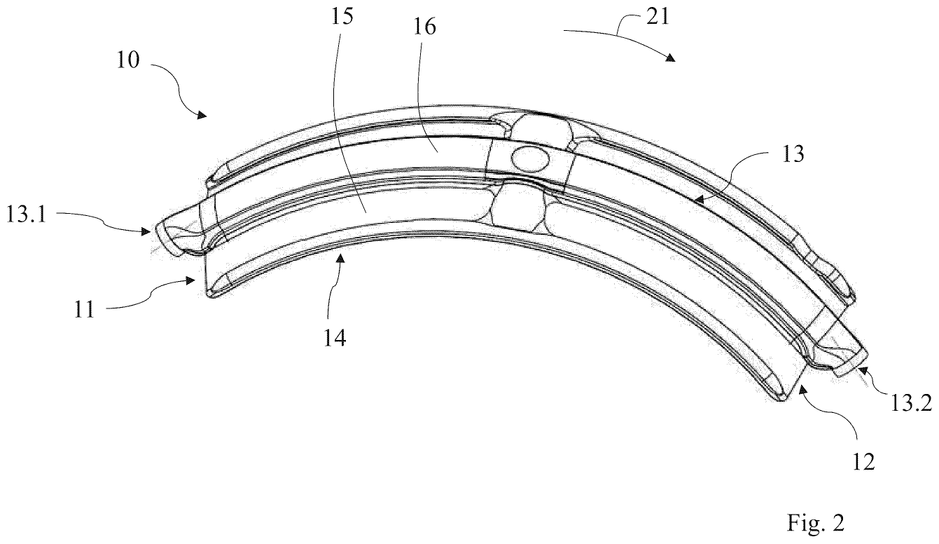

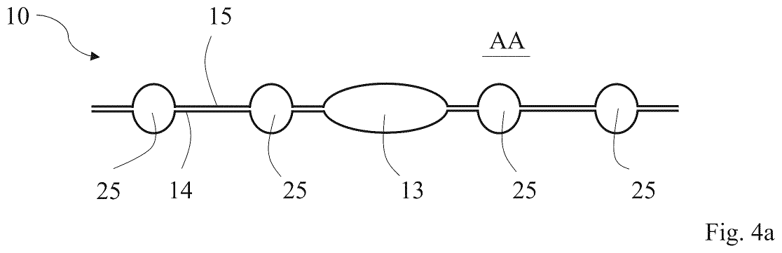

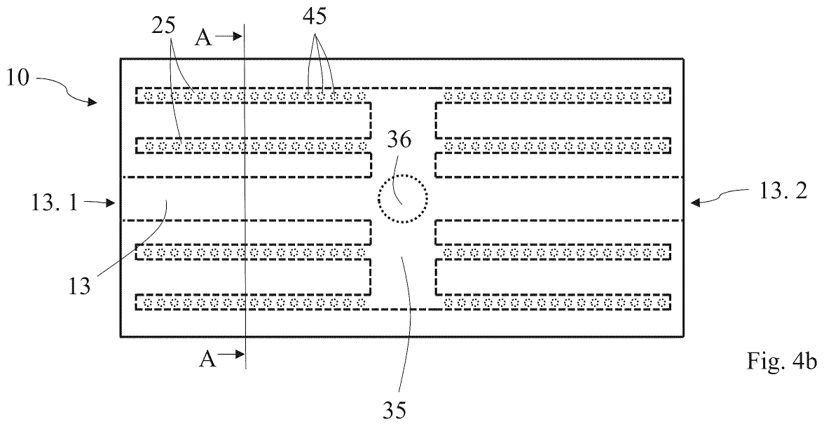

FIG. 2 illustrates a panel segment 10 for a cooling panel which can be assembled from a plurality of panel segments 10. With respect to a circumferential direction 21, the panel segment 10 comprises a first end 11 and a circumferentially opposite second end 12. Between the first and second end 11, 12, a circumferential distribution channel 13 extends, which is covered in the oblique view of FIG. 2 (see for instance FIGS. 4a and 4b in further detail). At the first end 11, the circumferential distribution channel 13 has a first interface 13.1, and it has a second interface 13.2 at the circumferentially opposite second end 12. Via these interfaces 13.1, 13.2, the circumferential distribution channel 13 can be connected to respective circumferential distribution channels of neighboring panel segments.

The panel segment 10 of FIG. 2 is assembled from an inner sheet 14 (covered in the oblique view of FIG. 2), an outer sheet 15 and an additional channel sheet 16, wherein the sheets are respectively made of sheet metal and materially connected to each other, e.g. by brazing or welding.

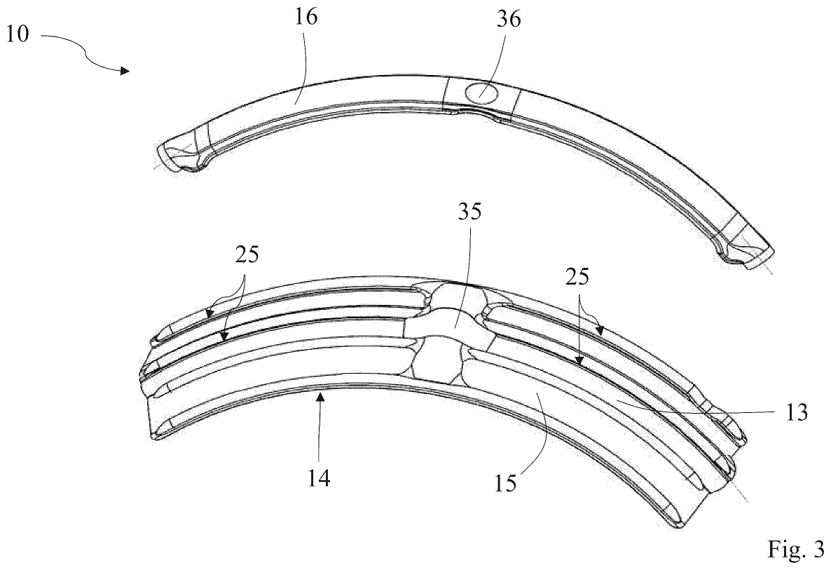

FIG. 3 shows a partially exploded view of the panel segment 10, the additional channel sheet 16 taken off. The circumferential distribution channel 13 is radially defined between the outer sheet 15 and the additional channel sheet 16. Radially between the inner sheet 14 and the outer sheet 15, a plurality of circumferential cooling channels 25 are defined (covered in the oblique view of FIG. 3 by the outer sheet 15), see in further detail below. Further, an axial distributor volume 35 is radially defined between the inner and the outer sheet 14, 15, which is fluidically connected to the circumferential cooling channels 25.

Via the axial distributor volume 35, the cooling channels 25 can be supplied with a cooling fluid, the cooling fluid supplied via the circumferential distribution channel 13 and/or via an interface 36 provided to connect the axial distributor volume 35 from radially outside. Considering a cooling panel comprising a plurality of circumferentially consecutive panel segments, only one or some of them may be provided with an open interface, the remaining panel segments being supplied via the circumferential distribution channel 13 from neighboring panel segments 10.

FIG. 4a shows a panel segment 10 in an axial cross-section, the sectional plane lying parallel to the length axis 2 (see FIG. 1) which coincides with an axis of curvature of the panel segment 10. Generally, in this disclosure, the like reference numerals indicate the like parts or parts having the like function, and reference is made to the description of the respectively other figures as well. In contrast to the panel segment 10 discussed above, the embodiment in FIG. 4a does not comprise an additional channel sheet, instead the circumferential distribution channel 13 is radially defined between the inner and the outer sheet 14, 15, like the circumferential cooling channels 25.

FIG. 4b illustrates the panel segment 10 of FIG. 4a in a schematic radial top view, in which also the sectional plane AA is indicated. This schematic top view illustrates the arrangement of the channels, namely the circumferential distribution channel 13 with its interfaces 13.1, 13.2. In fluidical connection thereto, the axial distributor volume 35 is arranged, which supplies the individual cooling channels 25. The cooling channels 25 are respectively provided with a plurality of cooling holes 45, through which the cooling fluid is ejected radially inwards in operation.

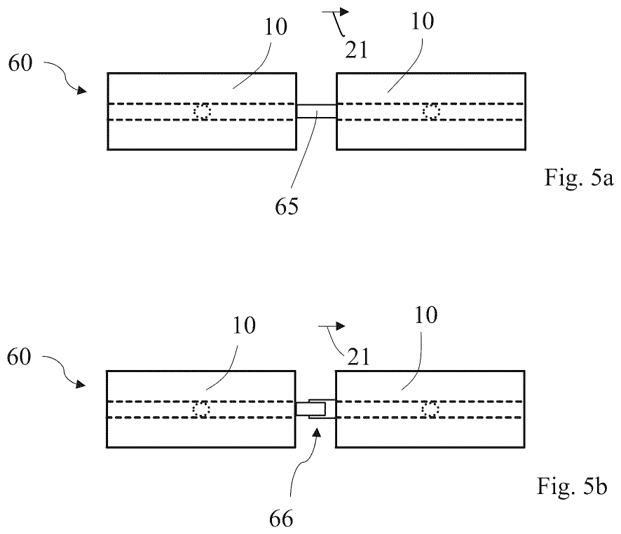

FIGS. 5a and 5b illustrates possibilities of connecting panel segments 10 to form a cooling panel 60. For a connection allowing for a certain relative displacement in the circumferential direction 21, a flexible jumper tube 65 may be applied (FIG. 5a). FIG. 5b illustrates an alternative, namely a sliding female-male type connection 66.

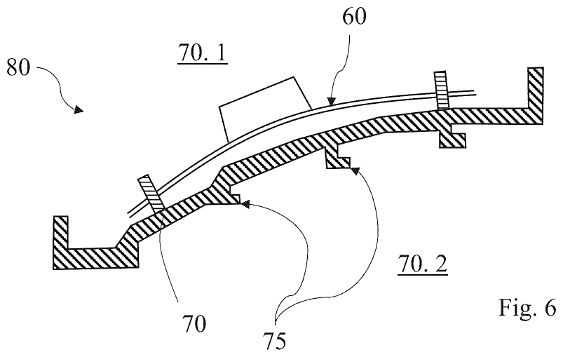

FIG. 6 illustrates a part of a module 80, i.e. shows a casing structure 70 with a cooling panel 60 mounted on its radial outside 70.1. On its radially opposite inner side 70.2, mounting structures 75 are provided on the casing structure 70, e.g. to mount a stator vane, sealing structures or the like.

### LIST OF REFERENCE CHARACTERS

| | |
|---|---|
| Turbomachine | 1 |
| Compressor | 1a |
| combustion chamber | 1b |
| turbine | 1c |
| fan | 1d |
| longitudinal axis | 3 |
| panel segment | 10 |
| first end | 11 |
| second end | 12 |
| circumferential distribution channel | 13 |
| first interface | 13.1 |
| second interface | 13.2 |
| inner sheet | 14 |
| outer sheet | 15 |
| additional channel sheet | 16 |
| circumferential direction | 21 |
| plurality of cooling channels | 25 |
| distributor volume | 35 |
| interface | 36 |
| plurality of cooling holes | 45 |
| cooling panel | 60 |
| flexible jumper tube | 65 |
| sliding female-male type connection | 66 |
| casing structure | 70 |
| radial outside | 70.1 |
| inner side | 70.2 |
| mounting structures | 75 |
| part of a module | 80 |

What is claimed is:

1. A panel segment for a cooling panel for a casing structure of a turbomachine, the panel segment comprising:
an inner sheet made of sheet metal; and
an outer sheet made of sheet metal;
the outer sheet being arranged radially outside of the inner sheet and being materially connected to the inner sheet,
circumferential cooling channels being defined between the inner sheet and the outer sheet,
each circumferential cooling channel being provided with a row of cooling holes configured to eject cooling fluid radially inwards,
the panel segment further defining an axial distributor volume, configured to supply the circumferential cooling channels with the cooling fluid,
the panel segment further defining a circumferential distribution channel in fluid communication with the axial distributor volume,
the circumferential distribution channel extending from a first end to a second end of the panel segment, the first end and the second end lying circumferentially opposite,
the circumferential distribution channel having a first interface at the first end and a second interface at the second end, the first interface and the second interface configured to be connected to a respective neighboring panel segment.

2. The panel segment as recited in claim 1 wherein the circumferential distribution channel is radially defined by at least one of the inner sheet and the outer sheet.

3. The panel segment as recited in claim 2 wherein the circumferential distribution channel is radially defined between the inner sheet and the outer sheet.

4. The panel segment as recited in claim 1 further comprising:
an additional channel sheet made of sheet metal, the circumferential distribution channel being radially defined by the additional channel sheet.

5. The panel segment as recited in claim 4 wherein the circumferential distribution channel is radially defined between the additional channel sheet and one of the inner sheet and the outer sheet.

6. The panel segment as recited in claim 5 wherein the additional channel sheet is arranged radially outside of the outer sheet, the circumferential distribution channel being defined radially inwards by a radially outer surface of the outer sheet.

7. The panel segment as recited in claim 1 wherein the sheet metal has a thickness of at least 0.4 millimeter.

8. The panel segment as recited in claim 7 wherein the sheet metal has a thickness of at most 2.5 millimeter.

9. The panel segment as recited in claim 1 wherein the sheet metal has a thickness of at most 2.5 millimeter.

10. A cooling panel comprising:
a first panel segment as recited in claim 1 and
a second panel segment comprising:
a second inner sheet made of sheet metal; and
a second outer sheet made of sheet metal;
the second outer sheet being arranged radially outside of the second inner sheet and being materially connected to the inner sheet,
second circumferential cooling channels being defined between the second inner sheet and the second outer sheet,
each second circumferential cooling channel being provided with a second row of second cooling holes configured to eject cooling fluid radially inwards,
the second panel segment further defining a second axial distributor volume, configured to supply the second circumferential cooling channels with the cooling fluid,
the second panel segment further defining a second circumferential distribution channel in fluid communication with the second axial distributor volume,
the second circumferential distribution channel extending from a third end to a fourth end of the second panel segment, the third end and the fourth end lying circumferentially opposite,
the second circumferential distribution channel having a third interface at the third end and a fourth interface at the fourth end;
a fluidical connection being formed between the first interface of the first panel segment and the fourth interface of the second panel segment.

11. The cooling panel as recited in claim 10 wherein the fluidical connection is formed by a flexible jumper tube or by a sliding female-male type connection.

12. The cooling panel as recited in claim 10 further comprising a plurality of further panel segments arranged to form a closed ring with the first panel segment and the second panel segment, wherein each panel segment of the plurality of panel segments comprises a further circumferential distribution channel extending between ends of the respective panel segment, the ends lying circumferentially opposite.

13. The cooling panel as recited in claim 12 wherein the further circumferential distribution channels of the plurality of further panel segments and the circumferential distribution channel and the second distribution channel are fluidically connected to form a continuous channel over the whole circumference.

14. A module for a turbomachine, the module defining at least a axial section of a gas channel and comprising:
a casing structure arranged radially outside of the axial section of the gas channel;
a cooling panel as recited in claim 10;
wherein the cooling panel is mounted radially outside of the casing structure and configured to cool the casing structur by ejecting cooling fluid from the cooling holes radially inwards.

15. A method of employing the module as recited in claim 14 in a turbomachine, the method comprising:
distributing the cooling fluid circumferentially in the cooling panel through the circumferential distribution channels of the panel segments; and
ejecting the cooling fluid from the cooling holes radially inwards onto the casing structure.

16. A method of manufacturing the panel segment as recited in claim 1, the method comprising materially joining the inner sheet and the outer sheet.
